(19) United States
(12) Patent Application Publication
(10) Pub. No.: US 2009/0278269 A1
(43) Pub. Date: Nov. 12, 2009

(54) METHOD FOR MANUFACTURING MOLD

(75) Inventor: HSIN-HUNG CHUANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/261,314

(22) Filed: Oct. 30, 2008

(30) Foreign Application Priority Data
May 6, 2008 (CN) 200810301423.1

(51) Int. Cl. B29D 11/00

(52) U.S. Cl. 264/2.5

(57) ABSTRACT

One present embodiment provides a method for manufacturing a mold. In the method, firstly, a master die is provided. The master die includes a molding surface, the molding surface having a plurality of predefined structures thereon. Secondly, a melted PDMS material is applied on the molding surface using a spin coating process. Thirdly, the melted PDMS material is cured to form a mold. Finally, the master die is removed.

### CROSS REFERENCE TO RELATED APPLICATION

This application is related to commonly-assigned copending application Ser. No. 12/138,275, entitled “METHOD FOR MANUFACTURING FILM COATED COMPOSITE LENS” (attorney docket number US 15481). Disclosures of the above-identified application are incorporated herein by reference.

### BACKGROUND

1. Technical Field

The present invention relates to molds for lenses, and particularly to a method for manufacturing a soft, elastic polydimethylsiloxane (PDMS) mold for lenses.

2. Description of Related Art

Micro-lenses with lens diameters of a few to several hundred micrometers are extensively applied to optical devices such as detectors and emitters to boost optical efficiency. Many different fabrication technologies, such as the photoresist reflow method, microjet technique, gray scale method, have been proposed in the literature. However, most of these technologies are suitable for micro-lens array with spherical surfaces and methods for low-cost fabrication of arrays of uniform refractive micro-lenses are still limited.

What is needed, therefore, is a method for manufacturing a mold of lenses to overcome the above described shortcomings

### SUMMARY

One exemplary embodiment provides a method for manufacturing a mold. In the method, firstly, a master die is provided. The master die includes a molding surface, the molding surface having a plurality of predefined structures thereon. Secondly, a melted PDMS material is spin coated on the molding surface. Thirdly, the melted PDMS material is cured to form a mold. Finally, the master die is moved.

### BRIEF DESCRIPTION OF THE DRAWINGS

Many aspects of the present embodiment can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a flow chart of a method for manufacturing a mold of lenses in accordance with a present embodiment.

FIG. 2 is a schematic, cross-sectional view of a master die in accordance with an exemplary embodiment.

FIG. 3 illustrates a spin coating step in the method according to the exemplary embodiment.

FIG. 4 is a schematic, cross-sectional view of the master die after the spin coating step according to the exemplary embodiment, a mold of lenses being formed on the master die.

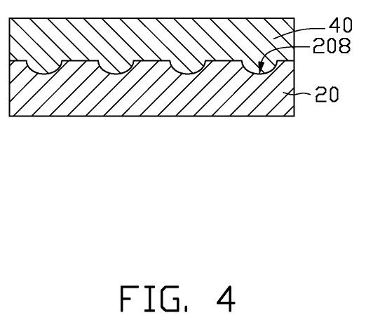

FIG. 5 is a schematic, cross-sectional view of the mold according to the exemplary embodiment.

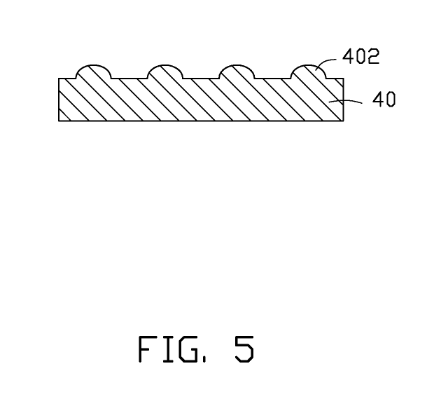

### DETAILED DESCRIPTION OF THE EMBODIMENTS

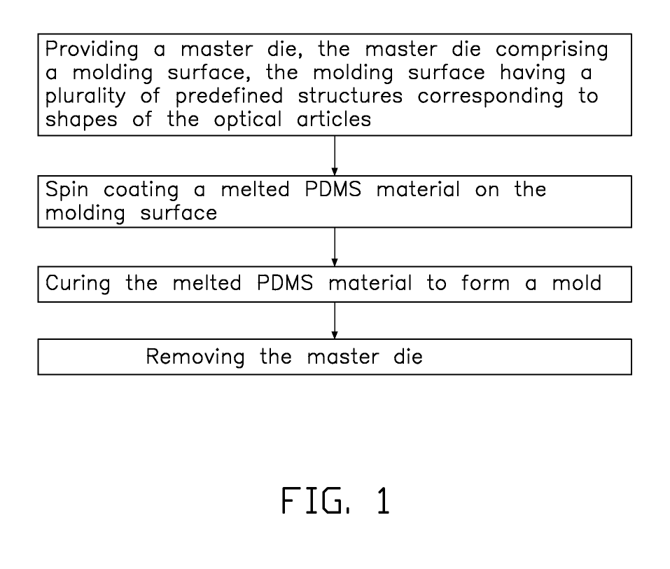

Referring to FIG. 1, an exemplary method for manufacturing a number of lenses includes the following steps.

Step 1: a master die 20 is provided.

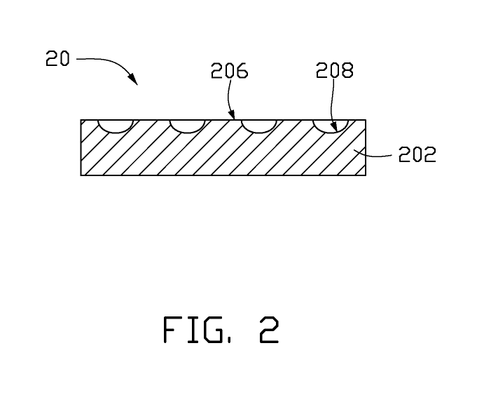

Referring to FIG. 2, the master die 20 includes a molding surface 206. The molding surface 206 defines a number of microstructures 208 thereon. The microstructures 208 are arranged in an array. The microstructures 208 have surface structures similar with surfaces of optical articles such as optical portions of lenses. The microstructures 208 can be either convex structures or concave structures. The convex surfaces or the concave surfaces of the microstructures 208 can be spherical or aspherical. In the present embodiment, the microstructures 208 are concave structures and have aspherical surfaces.

The master die 20 is comprised of a material selected from a group consisting of plastic and metal. In the present embodiment, the master die 20 is comprised of aluminum.

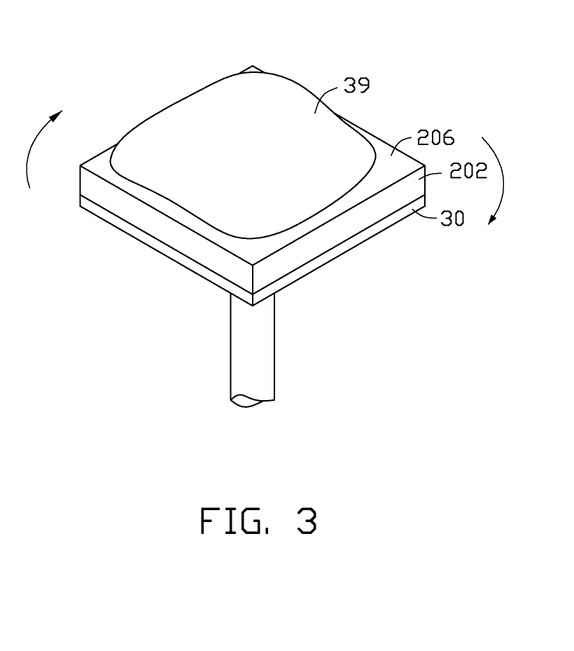

Step 2: a melted polydimethylsiloxane (PDMS) material 39 is applied on the molding surface 206, as shown in FIG. 3.

Referring to FIG. 3, an excess amount of the melted PDMS 39 is directly applied on the molding surface 206 of the master die 20. Then, a spin coating process is performed. The master die 20 is placed on a substrate 30 (also called spin coater, or spinner), and is then rotated at high speed in order to spread the melted PDMS 39 by centrifugal force. The substrate 30 continues to rotate while the melted PDMS 39 spins off the edges of the substrate 30, until a desired thickness of a mold 40 of lenses is achieved. The effect of the liquid surface tension results in good surface uniformity, providing that the liquid PDMS is at desired thickness. The higher the angular speed of spinning, the thinner the mold 40 is. The thickness of the mold also depends on the concentration of melted PDMS 39. To form a mold 40 about 1 micrometer thick, the melted PDMS 39 is typically spun at 20 to 80 Hz for 30 to 60 seconds.

A mold release agent (not shown) can be coated on the molding surface 206 prior to the step of spin coating the melted PDMS 39. More specifically, the mold release agent, such as a siloxane liquid, is in a bottle, and then the bottle and the master die 20 are enclosed in a vacuum tank. Under a predetermined temperature, the gas volatilized by the mold release agent is attached on the molding surface 206.

Step 3: the melted PDMS 39 is cured to form the mold 40. In the present embodiment, the melted PDMS 39 is heated to 125 Celsius degrees for about 15 minutes.

Step 4: the master die 20 is removed from the mold 40. As a result, the obtained mold 40 has microstructures 402 corresponding to the surfaces of optical articles such as optical portions of lenses.

While certain embodiment has been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. A method for manufacturing a mold for optical articles, comprising the steps of:
providing a master die, the master die comprising a molding surface, the molding surface having a plurality of predefined structures corresponding to shapes of the optical articles;
spin coating a melted PDMS material on the molding surface;
curing the melted PDMS material to form a mold; and
removing the master die.

2. The method of claim 1, further comprising a step of coating a mold release agent on the molding surface prior to the step of spin coating the melted PDMS material on the molding surface.

3. The method of claim 2, wherein the mold release agent includes a siloxane liquid.

4. The method of claim 1, wherein the melted PDMS material is heated to a temperature of about 125 Celsius degrees.

5. The method of claim 4, wherein the melted PDMS material is maintained at the temperature of about 125 Celsius degrees for about 15 minutes.

6. The method of claim 1, wherein the predefined structures are microstructures arranged in an array.

7. The method of claim 6, wherein the microstructures are convex structures or concave structures.

8. The method of claim 6, wherein the microstructures are spherical structures or aspherical structures.
